(19) United States
(12) Patent Application Publication
(10) Pub. No.: US 2007/0093917 A1
(43) Pub. Date: Apr. 26, 2007

(54) Storing and accessing relay ladder logic modules in a relational database

(75) Inventor: Jethro F. Steinman, Havertown, PA (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 11/255,233

(22) Filed: Oct. 20, 2005

(51) Int. Cl. G05B 11/01

(52) U.S. Cl. 700/18

(57) ABSTRACT

Devices, systems and methods for providing relay ladder logic templates are disclosed. The exemplary system may have one or more actuators and sensors. The exemplary system may have one or more actuators and sensors and a controller and memory for storing and executing relay ladder logic instance modules and template modules. The exemplary system may also have a general purpose processor and memory for storing one or more instance modules, template modules, and elements of the modules in a relational database. One or more buses may be in communication with the one or more actuators and sensors, the controller and memory and the general purpose processor and memory.

### FIELD OF THE INVENTION

The present invention relates generally to modules for relay ladder logic, and more particularly to storing relay ladder logic modules and elements in a relational database to perform automated and semi-automated updates

### BACKGROUND OF THE INVENTION

Many automated processes are controlled using industrial control systems that use special purpose processors. Many of the control systems rely on a variety of actuators, drive devices, and sensors to perform a variety of tasks. For example, a factory may use the control systems in an automated assembly line to move, manipulate, and test the product being assembled. The control systems often are required to handle large amounts of input and output data. The control systems may also be required to be robust and reliable. The control systems may also be required to react rapidly in a real-time environment.

The processors may require specifically designed programming languages. These programming languages are often more structured based on the above requirements of the processor and control system. Relay ladder logic is an example of a programming language designed for control systems. The structure of relay ladder logic may limit the tools and techniques used by the programmer. Relay ladder logic often requires software programmers with specific skills unique to these languages.

The software programmers develop code that performs various tasks when executed by a controller. As the tasks become more complex, the code used to perform these tasks also becomes increasingly more complex. During the programming process, software programmers often develop multiple programs using portions of code in a repetitive structure or copying portions of code from previously designed programs. These programs or portions of code may be referred to as modules. These modules may have variables, rungs, coils, contacts, or other elements that may need to be modified within the modules. The software programmer may have made several programs that require a single element to be changed for each program.

Accordingly, an efficient and effective system and method is needed for storing and modifying modules and elements of modules for relay ladder logic.

### SUMMARY OF THE INVENTION

It is, therefore, an objective of the present invention to provide devices, systems, and methods for providing and editing modules and elements of the modules for relay ladder logic. An exemplary method may store a template module and one or more template elements associated with relay ladder logic instructions in a relational database. The method may replicate the template module and the template elements. The method may store the replicated template module and the template elements as modules and module elements in the relational database.

Alternative aspects of the system may have the following features. A general purpose processor may be used to store the template module and one or more template elements, replicate the template module and the template elements, and store the replicated template module and the template elements as instance modules and module elements. The elements may be rungs, coils, constants, contacts, or variables. The template elements may be template module defining elements and the general purpose processor edits one or more template defining elements in the relational database and automatically causes edits to respective elements of the instance modules in the relational database. The template elements may be non-template defining elements and a general purpose processor edits one or more non-template defining elements of the template module in the relational database. The method may access one or more module elements in the relational database by a controller or via a general purpose processor. The method may provide direct editing of the instance modules.

### BRIEF DESCRIPTION OF THE DRAWINGS

The above and other objectives and advantages of the present invention will be apparent upon consideration of the following detailed description, taken in conjunction with the accompanying drawings, in which like reference numbers refer to like parts throughout, and in which:

FIG. 1 is a generalized schematic of an exemplary system for storing a relay ladder logic module and elements according to an embodiment of the present invention.

FIG. 2 is a block diagram of an exemplary method for storing a relay ladder logic instance module and elements according to an embodiment of the present invention.

FIG. 3 is a block diagram of an exemplary method for storing a relay ladder logic instance module and elements according to an embodiment of the present invention.

FIG. 4 is a block diagram of an exemplary method for accessing a relay ladder logic module and elements according to an embodiment of the present invention.

FIG. 5 is a high level Unified Modeling Language (UML) class diagram of an exemplary system for storing a relay ladder logic module and elements according to an embodiment of the present invention.

### DETAILED DESCRIPTION OF THE INVENTION

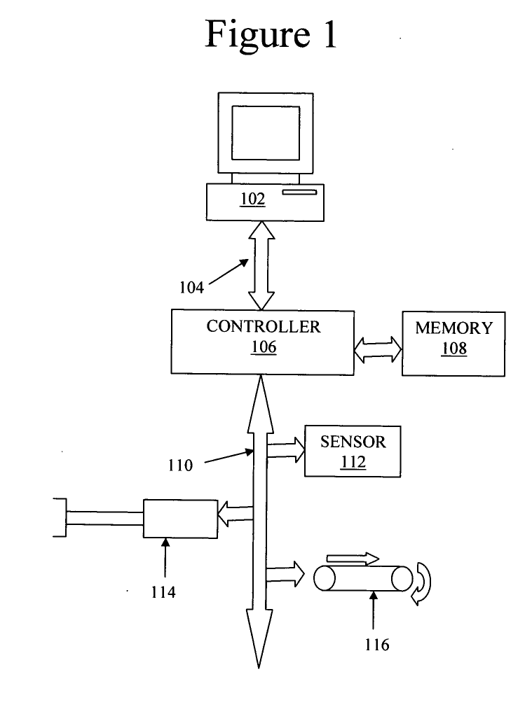

Referring to FIG. 1, an exemplary control system 100 provides a real-time process control system for executing relay ladder logic instructions which have been loaded as a set of modular programs. Control system 100 may have general purpose computer 102 for interfacing with a control system programmer. The programmer designs and enters instructions for producing the relay ladder logic code. Control system 100 may utilize a Graphic User Interface (GUI), or other suitable interface, to allow the programmer to modify relay ladder logic modules and elements associated with the modules.

In the design process, the programmer may select and/or create template modules from a variety of sources, for example, but not limited to, a library or previously designed instance modules. The programmer may manipulate elements of the template module based on the needs of the design process. For example, variables, rungs, contacts, coils, or constants of the module may be modified. The instance module and respective elements are stored in a relational database, or any other suitable storage means.

A relational database is a collection of data items organized as a set of structured tables from which data can be accessed, searched or reassembled in many different ways without having to reorganize the database tables. Each table (which is sometimes referred to as a relation) contains one or more data categories in columns. Each row contains a unique instance of data for the categories defined by the columns. The relational database may be extended after the database is created; a new data category can be added without requiring modification of all existing applications.

Control system 100 may provide the programmer with tools to make the design process easier and similar to tools offered in other programming paradigms. Control system 100 downloads the relay ladder logic instance module from general purpose computer 102 to controller 106 and memory 108 via bus 104 or other suitable communications network. The relay ladder logic instance module are stored in the memory 108.

Controller 102 may be coupled to a variety of control devices via control bus 110, or any other suitable coupling means. Control system 100 may include sensor 112, actuator 114, and conveyor belt 116. Control system 100 is not limited to these exemplary devices and may include any other suitable device or devices. Each device 112, 114, 116, or other suitable device or devices may have input and output parameters associated with such device. The input and output parameters are communicated to controller 106 via control bus 110.

For example, sensor 112 may have an active and an inactive state. In operation, sensor 112 normally may be in an inactive state and activated when a package passes in front of the sensor. Actuator 114 and conveyor belt 116 may also have an active and an inactive state.

Controller 106 executes the relay ladder logic instance module. The instance module may cause controller 106 to activate actuator 114 and conveyor belt 116 when sensor 112 is activated. Thus, when a package is observed, controller 106 retrieves the instructions for carrying out certain predefined tasks from memory 108. Controller 106 executes the instance module causing actuator 114 and conveyor belt 116 to be activated. Actuator 114 pushes the package onto conveyor belt 116. Conveyor belt 116 moves the object to the next stage in the manufacturing process.

The above example is a simple example and is provided for merely illustrative purposes. Those skilled in the art will appreciate that other control process may be used and that control system 100 may include a large quantity of devices that are activated in rapid succession. Moreover, relay ladder logic instance modules may include a large quantity of instructions that carry out various and perform a variety of complex tasks.

Architecturally in terms of hardware, controller 106 may include one or more input and output interface devices. The local interface may have additional elements, which are omitted for simplicity, such as controllers, buffers (caches), drivers, repeaters, and receivers, or any other suitable device or devices to enable communications. Further, the local interface may include address, control, and/or data connections to enable appropriate communications among the components of the device network. General purpose computer 102 may also include additional hardware omitted for the convenience of illustrative purposes. General purpose computer 102 may be, for example, a server or any other suitable device. In the case where general purpose computer 102 is a server, it may be coupled to multiple workstations and allow multiple programmers to modify the relay ladder logic modules.

The systems and methods may also be incorporated in software used with a computer or other suitable operating device of the control system. The software stored or loaded in the memory may include one or more separate programs, each of which comprises an ordered listing of executable instructions for implementing the methods and systems of the invention. The software may work in conjunction with an operating system. The operating system essentially controls the execution of the computer programs, such as the software stored within the memory, and provides scheduling, input-output control, memory management, and communication control and related services.

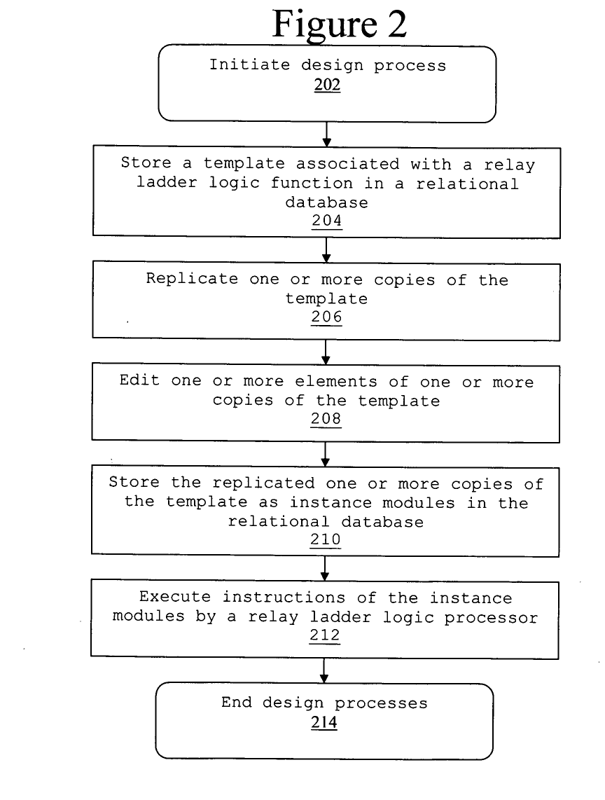

Referring to FIG. 2, a flow chart illustrates aspects of an exemplary method for managing modules stored in a relational database for relay ladder logic 200. The design process is initiated by the programmer via an interface of general purpose computer 102 (block 202). General purpose computer 102 stores a template module associated with a relay ladder logic function in a relational database (block 204). The programmer may access and modify the template module via the interface of general purpose computer 102. For repetitive tasks or equipment, the programmer may make copies of the template to aid in the programming process. Each copy acts as an independent instance module of the program defined by the template (block 206). Constraints, variables, and other aspects of the template modules may need to be modified by the programmer (block 208). General purpose computer 102 stores the replicated copies of the templates as instance modules in the relational database (block 210). The templates modules and instance modules are stored according to a scheme which knows about all the elements or primitives that make up the program (rungs, contacts, coils, constants, variables). This allows the modifications made by the programmer to propagate to a set of modules designated by the programmer or system. A program in executable form may be generated from the contents of the relational database. The executable program is loaded to controller 106. Controller 106 executes the instance module (block 212). The design process is completed (block 214).

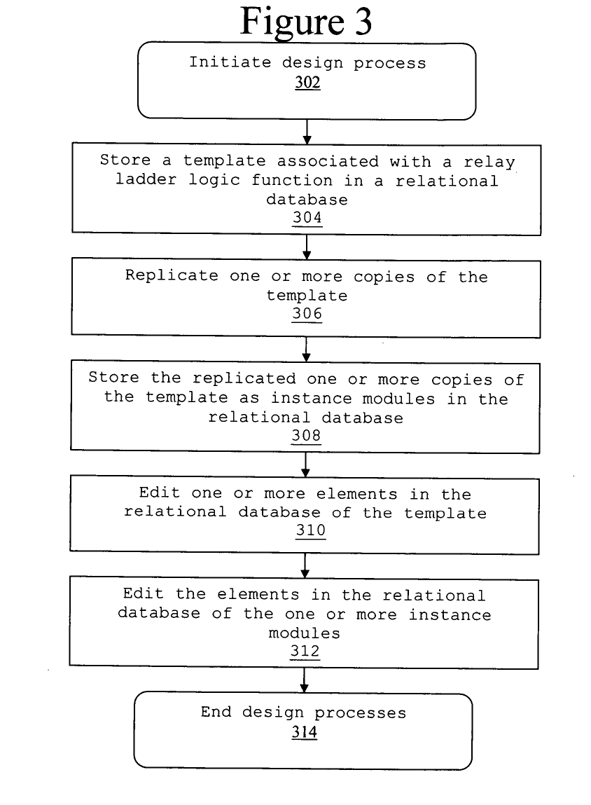

Referring to FIG. 3, a block diagram illustrates aspects of an exemplary method for storing and editing elements of the template module stored in a relational database for relay ladder logic 300. The design process is initiated by the programmer via an interface of general purpose computer 102 (block 302). General purpose computer 102 stores a template module associated with a relay ladder logic instance module in a relational database (block 304). For repetitive tasks or equipment, the programmer may make copies of the template module to aid in the programming process (block 306). The copies of the one or more templates module are stored as instance modules in the relational database (block 308). The instance modules have a relationship to the parent template modules which allows the programmer to make edits in the template module that propagate to the instance modules. The programmer may make these modifications to the elements of the template module via the interface of general purpose computer 102 (block 310). The elements of the template modified by the programmer may propagate from the template module to the instance modules. The programmer may decide at what point during the design process to propagate the changes from the template module to the instance modules (block 312). The process allows the modifications made by the programmer to propagate throughout the relay ladder logic instructions and ensures that all elements have been modified. The programmer may execute the instance modules with the controller 106. The design process may be completed by the programmer (block 314).

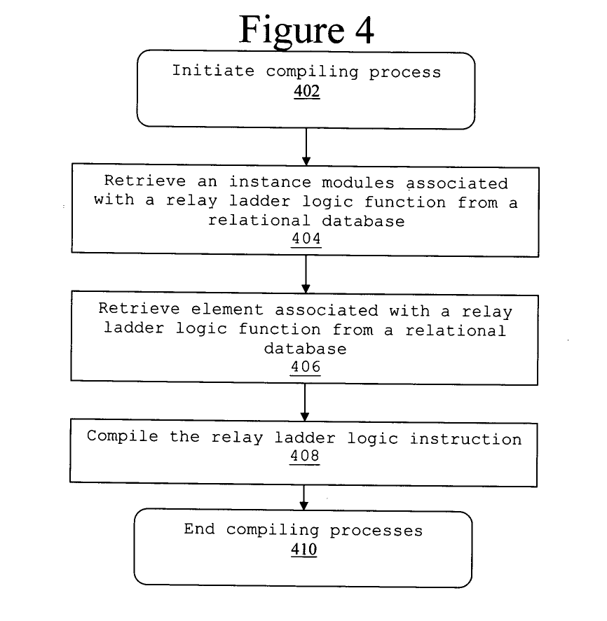

FIG. 4 is a block diagram of an exemplary method for accessing a relay ladder logic instance module and elements according to an embodiment of the present invention. General purpose computer 102 initiates compiling of the instructions (block 402). General purpose computer 102 retrieves an instance module associated with a relay ladder logic function from a relational database (block 404). General purpose computer 102 retrieves the elements associated with the relay ladder logic instance module from a relational database (block 406). Although, the action of block 404 and block 406 are identified separately these action may be carried out in one action. General purpose computer 102 compiles the relay ladder logic instructions (block 408). General purpose computer 102 may download the compiled instructions to controller 106. The compiling process is completed (block 410).

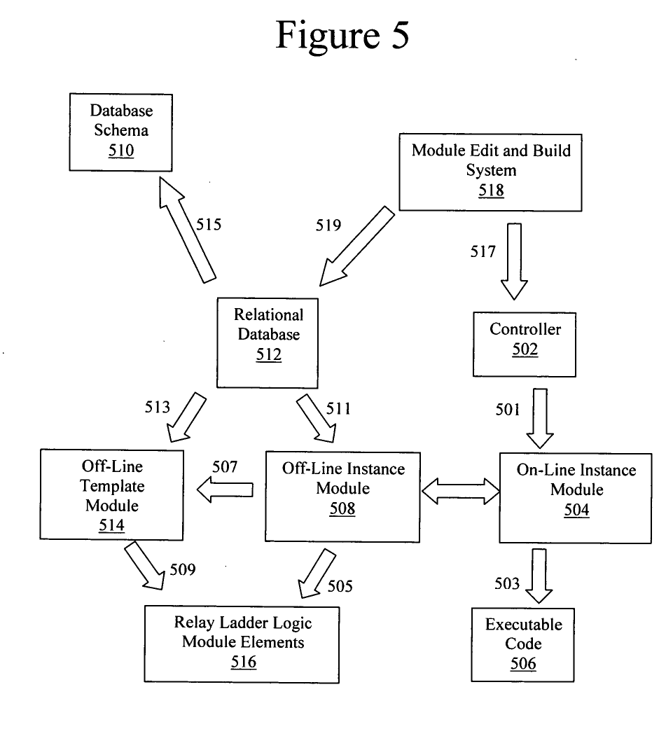

Referring to FIG. 5, a Unified Modeling Language (UML) class diagram 500 of an exemplary system provides a high level focus of abstraction. The UML class diagram provides a greater, more detailed look at the various exemplary components of the system. Controller 502 is capable of running relay ladder logic instance modules which are loaded to controller 502. The controller 502 executes the on-line instance module 504 (arrow 501). The various relay ladder logic instance modules which run on controller 502 may be unrelated to each other and designed using different processes. The instance modules may also be similar in the sense that they correspond to the same parent template module or completely distinct and not designed using a template module.

These instance modules may be viewed as on-line instance modules 504. The on-line instance modules 504 are composed of executable code (arrow 503). On-line instance module 504 may run within controller 502. The on-line instance module representation may be viewed differently based on the type of controller under consideration. On-line instance module 504 may consist of entirely executable code 506. Executable code 506 forms a list of instructions which can be executed by controller 502

This may be different from what makes up off-line instance module 508. Off-line instance module 508 may be viewed as a representation of a relay ladder logic module. Off-line instance module 508 is composed of relay ladder logic module elements 516 (arrow 505). Off-line instance module 508 is a collection of relay ladder logic module primitive elements organized as tables according to schema 510 within a relational database 512. Elements 516 make up the off-line instance module 508. Examples of elements 516 may be rungs, contacts, coils, constant references and variable references. Elements 516 are small-grained enough so that the queries operating upon the relational database 512 can be effective in adding, deleting, or changing elements 516 that make up individual modules. Off-line instance modules 508 may be specializations of off-line template module 514 (arrow 507). Off-line instance modules 508 may have a relationship with a corresponding off-line template module 514. Off-line template module 514 may be modified by the programmer. The programmer may then trigger the propagation of changes to the respective off-line instance modules 508. Off-line instance module 508 may be edited individually without breaking the relation to the parent off-line template module 514. Off-line template module 514 may be composed of relay ladder logic module elements 516 (arrow 509). Elements of off-line instance module 508 which match those of the parent off-line template module 514 are template defining elements. Elements that may be edited (added, deleted or changed) without impacting the form of the parent template are not template defining elements.

Off-line instance modules 508 may come into existence either by direct editing or by instantiation (specialization) from off-line template module 514. Within Relational Database 512 modules are represented as a collection of fine-grained elements 516 organized according to the database schema 510. The relational database 512 may persist and manipulate the off-line instance module 508 (arrow 511). The relational database 512 may also persist and manipulate the off-line template module 514 (arrow 513). The relational database 512 may also be organized according to the database schema 510 (arrow 515). Elements 516 encoded within the schema and stored within the table structure of relational database 512 may be viewed as relay ladder logic module elements. Each module may have elements 516 that have some features which are common and some that are distinct. Among the features which elements 516 may have in common is a declaration of whether the element is considered to be template defining or not template defining. Elements 516 which are declared template defining may change if and when the programmer modifies the parent off-line template module 514 template and commands that the parent off-line template module 514 changes be propagated to children. Elements 516 which are declared not template defining may be edited independent of characteristics of the parent template and are not impacted by propagation of changes from the parent template.

As previously discussed, there are various different kinds of relay ladder logic module elements 516. These different types of elements persist within the relational database 512. The relations between them within the relational database 512 encode the order and flow of execution that will be realized by the module when it is transformed from the off-line instance module 508 form to an executable on-line instance module 504 or program. Each element 516 may have common features which allow it to be stored within the schema and handled by queries but also has unique features which may distinguish the elements, for example, the nature of a rung from the nature of a constant reference.

Within the relational database 512, off-line instance modules 508 may have a relationship with off-line template modules 514. When this relationship exists the template may be viewed as the “parent” that “spawned” the instance and that manages those primitives of child off-line instances modules 508 which have been declared template defining. Elements 516 of the off-line template module 514 may be declared template defining or not template defining.

For example, suppose Template A has rung RungA1, RungA1 may have been declared as template defining, and InstanceA1 and InstanceA2 may have been created as children of Template Module A. The programmer may choose to delete RungA1 from Template A. The programmer may command propagation of the change made to Template Module A to the children of Template Module A. This will cause RungA1 to be automatically be deleted from InstanceA1 and InstanceA2.

According to a second example, Template B may contain a rung which triggers execution of a function block, the function block may have a constant valued input parameter of value 50.0, the constant value may be declared a template defining element, and three instances of Template B called InstanceB1, InstanceB2 and InstanceB3 may be provided. The programmer may edit Template B by changing the constant from 50.0 to 73.9. The programmer may then command propagation of the change to the children of Template B.

Relational Database 512 may be structured into a set of tables, each with its own fields and rows. The structure (schema) may be set up so that the database can effectively and efficiently support query operation needed in connection with the storage, editing and manipulation of the off-line modules.

The design of the schema allows for operations such as but not limited to the following. The association of a set of relay ladder logic module elements may provide a cohesive module. The ordering of relay ladder logic module elements may be in positions within an associated relay ladder logic rung. The ordering of rungs may be in order of their execution position within the module. The export of all relay ladder logic module elements may be combined into a textual module representation corresponding to a program that may be compiled.

Module edit and build system 518 may be a subsystem which works with relational database 512 to persist, manipulate, export and import modules. Module edit and build system 518 may direct program loads of the controller 502 (arrow 517). Module edit and build system 518 may direct program edits and loads of the relational database 512 (arrow 519). Module edit and build system 518 may be capable of exporting modules, rendering them into a textual representation susceptible to compilation and compiling the modules into executable form. Module edit and build system 518 may also be a subsystem that works with controller 502 to load the executable modules to controller 502 and cause them to be executed. Module edit and build system 518 may also provide a user-friendly graphical user interface to the programmer so that the modules may be edited and perused without knowledge of the intricacies of how modules are persisted or loaded. Module edit and build system 518 allows the programmer to, for example, edit template modules, edit instance modules, propagate template changes to instance modules, export instance modules for loading, and load instance modules to the controller 106. Module edit and build system 518 may also be considered one of the software subsystems hosted and executed by controller 106

It will be understood that the foregoing is only illustrative of the principles of the invention and that various modifications can be made by those skilled in the art without departing from the scope and spirit of the invention. Persons skilled in the art will appreciate that the present invention can be practiced by other than the described embodiments, which are presented for purposes of illustration rather than of limitation and that the present invention is limited only by the claims that follow.

What is claimed is:

1. A system for providing relay ladder logic modules, comprising:
one or more actuators and sensors;
a controller and memory for storing and executing relay ladder logic instance modules;
a general purpose processor and memory for storing one or more instance modules, template modules, and elements of the modules in a relational database; and
one or more buses in communication with the one or more actuators and sensors, the controller and memory and the general purpose processor and memory.

2. The system of claim 1, wherein the general purpose processor produces one or more instance modules and elements of the instance modules from a template module and one or more template elements stored in the relational database.

3. The system of claim 1, wherein the elements are selected from a group comprising rungs, coils, constants, and contacts of the instance modules.

4. The system of claim 1, wherein the elements are variables of the instance modules.

5. The system of claim 2, wherein the template elements are template defining elements and the general purpose processor edits one or more template defining elements in the relational database and causes edits to respective elements of the instance modules in the relational database.

6. The system of claim 2, wherein the template elements are non template defining elements and the general purpose processor edits one or more non template defining elements in the relational database of the template module and does not propagate edits to respective elements of the instance modules in the relational database.

7. The system of claim 2, wherein the instance modules are accessible for direct editing.

8. A method of managing modules for relay ladder logic, comprising the steps of:
storing a template module and one or more template elements associated with relay ladder logic instructions in a relational database;
specializing the template module and the template elements; and
storing the specialized template module and the specialized template elements as instance modules and instance elements in the relational database.

9. The method of managing modules for relay ladder logic of claim 8, wherein a general purpose processor stores the template module and one or more template elements, specializes the template module and the template elements, and stores the specialized template module and the specialized template elements as instance modules and instance elements in the relational database.

10. The method of managing modules for relay ladder logic of claim 8, wherein the template elements and the instance elements are selected from a group comprising rungs, coils, constants, and contacts.

11. The method of managing modules for relay ladder logic of claim 8, wherein the template elements and instance elements are variables.

12. The method of managing modules for relay ladder logic of claim 8, wherein the template elements are template defining elements and edits to the one or more template defining elements in the relational database automatically causes edits to respective instance elements of the instance modules in the relational database.

13. The method of managing modules for relay ladder logic of claim 8, wherein the template elements are non template defining elements and edits to one or more non template defining elements of the template module in the relational database does not cause edits to respective instance elements of the instance modules in the relational database.

14. The method of managing modules for relay ladder logic of claim 8, further comprising the step of, accessing the one or more instance module and instance elements in the relational database by a controller via a general purpose processor.

15. A machine-readable medium having instructions stored thereon for causing a machine to manage function blocks for relay ladder logic, comprising the steps of:
storing a template module and one or more template elements associated with relay ladder logic instructions in a relational database;
specializing the template module and the template elements;
storing the specialized template module and the specialized template elements as instance modules and instance elements in the relational database.

16. The machine-readable medium of claim 15, wherein the template elements and instance elements are selected from a group comprising rungs, coils, constants, and contacts.

17. The machine-readable medium of claim 15, wherein the template element and instance elements are variables.

18. The machine-readable medium of claim 15, wherein the template elements are template defining elements and edits to the one or more template defining elements in the relational database causes edits to respective instance elements of the instance modules in the relational database.

19. The machine-readable medium of claim 15, wherein the template elements are non template defining elements and edits to one or more non template defining elements of the template module in the relational database does not cause edits to respective instance elements of the instance modules in the relational database.

20. The machine-readable medium of claim 15, further comprising the step of,
accessing the one or more instance modules and instance elements in the relational database by a controller.
